(19) United States
(12) Patent Application Publication
(10) Pub. No.: US 2026/0075030 A1
(43) Pub. Date: Mar. 12, 2026

(54) NWDAF-ASSISTED APPLICATION DETECTION BASED ON DOMAIN NAME SERVICE (DNS)

(71) Applicant: Telefonaktiebolaget LM Ericsson (publ), Stockholm (SE)

(72) Inventors: Miguel Angel Muñoz De La Torre Alonso, Madrid (ES); Maria Luisa Mas Rosique, Tres Cantos (ES); Carlota Villasante Marcos, Madrid (ES); Victor Gomez-Hidalgo Perez, Torrijos Toledo (ES); Antonio Camas Maestre, Madrid (ES)

(21) Appl. No.: 19/105,968

(22) PCT Filed: Oct. 19, 2022
(86) PCT No.: PCT/IB2022/060051

§ 371 Date: Feb. 24, 2025

(30) Foreign Application Priority Data
Aug. 29, 2022 (EP) 22382802.1

(51) Int. Cl. H04L 61/4511; H04L 61/4541; H04L 101/365

(52) U.S. Cl. CPC H04L 61/4511; H04L 61/4541; H04L 2101/365

(57) ABSTRACT

Embodiments include methods for a network data analytics function (NWDAF) configured to assist with application detection in a communication network. Such methods include receiving, from a consumer network function (cNF) of the communication network, an analytic request related to assisted application detection and based on the analytic request, sending to a first DNS resolver associated with the communication network an exposure request for events related to fully qualified domain name (FQDN)-to-address mapping for application servers associated with applications. Such methods also include receiving from the first DNS resolver a first FQDN associated with a first application, in accordance with the exposure request, and based on the first FQDN, determining one or more packet flow descriptions (PFDs) associated with the first application. Such methods also include sending to the cNF an analytic result comprising the one or more PFDs, in accordance with the analytic request.

### TECHNICAL FIELD

The present application relates generally to the field of communication networks, and more specifically to techniques for detecting and/or classifying applications associated with encrypted user traffic in a communication network (e.g., a 5G network).

### INTRODUCTION

At a high level, the 5G System (5GS) consists of an Access Network (AN) and a Core Network (CN). The AN provides UEs connectivity to the CN, e.g., via base stations such as gNBs or ng-eNBs described below. The CN includes a variety of Network Functions (NF) that provide a wide range of different functionalities such as session management, connection management, charging, authentication, etc.

FIG. 1 illustrates a high-level view of an exemplary 5G network architecture, consisting of a Next Generation Radio Access Network (NG-RAN) 199 and a 5G Core (5GC) 198. NG-RAN 199 can include one or more gNodeB's (gNBs) connected to the 5GC via one or more NG interfaces, such as gNBs 100, 150 connected via interfaces 102, 152, respectively. More specifically, gNBs 100, 150 can be connected to one or more Access and Mobility Management Functions (AMFs) in the 5GC 198 via respective NG-C interfaces. Similarly, gNBs 100, 150 can be connected to one or more User Plane Functions (UPFs) in 5GC 198 via respective NG-U interfaces. Various other network functions (NFs) can be included in the 5GC 198, as described in more detail below.

In addition, the gNBs can be connected to each other via one or more Xn interfaces, such as Xn interface 140 between gNBs 100 and 150. The radio technology for the NG-RAN is often referred to as “New Radio” (NR). With respect the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells. NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

The NG RAN logical nodes shown in FIG. 1 include a Central Unit (CU or gNB-CU) and one or more Distributed Units (DU or gNB-DU). For example, gNB 100 includes gNB-CU 110 and gNB-DUs 120 and 130. CUs (e.g., gNB-CU 110) are logical nodes that host higher-layer protocols and perform various gNB functions such controlling the operation of DUs. A DU (e.g., gNB-DUs 120, 130) is a decentralized logical node that hosts lower layer protocols and can include, depending on the functional split option, various subsets of the gNB functions.

A gNB-CU connects to one or more gNB-DUs over respective F1 logical interfaces, such as interfaces 122 and 132 shown in FIG. 1. However, a gNB-DU can be connected to only a single gNB-CU. The gNB-CU and connected gNB-DU(s) are only visible to other gNBs and the 5GC as a gNB. In other words, the F1 interface is not visible beyond gNB-CU.

Another change in 5G networks (e.g., in 5GC) is that traditional peer-to-peer interfaces and protocols found in earlier-generation networks are modified and/or replaced by a Service Based Architecture (SBA) in which Network Functions (NFs) provide one or more services to one or more service consumers. This can be done, for example, by Hyper Text Transfer Protocol/Representational State Transfer (HTTP/REST) application programming interfaces (APIs). In general, the various services are self-contained functionalities that can be changed and modified in an isolated manner without affecting other services.

Furthermore, the services are composed of various “service operations”, which are more granular divisions of the overall service functionality. The interactions between service consumers and producers can be of the type “request/response” or “subscribe/notify”. In the 5G SBA, network repository functions (NRF) allow every network function to discover the services offered by other network functions, and Data Storage Functions (DSF) allow every network function to store its context. This 5G SBA model is based on principles including modularity, reusability and self-containment of NFs, which can enable network deployments to take advantage of the latest virtualization and software technologies.

Two 5GC NFs of particular interest are UPF and Network Data Analytics Function (NWDAF). UPF handles user plane (UP) traffic including packet inspection, packet routing and forwarding, traffic usage reporting, QoS handling, etc. Packet flow description (PFD) is a set of information enabling UPF detection of application traffic. Each PFD is identified by a unique PFD ID, which may be associated with a particular application. NWDAF interacts with other NFs to collect relevant data and provides network analytics information (e.g., statistical information of past events and/or predictive information) to other NFs.

Domain Name Service (DNS) is a fundamental Internet building blocks that is used when a user visits a website, sends an email, has an IM conversation, or does almost anything else online. When a user opens an application, a DNS client retrieves server IP address(es) for the application domain from a DNS resolver. Currently most DNS traffic today is sent unencrypted over UDP/TCP, but there are different IETF drafts proposing DNS encryption to prevent reading of DNS traffic in the middle between endpoints. Various proposals include DNS over HTTP/2 (DOH), DNS over TLS, DNSCrypt, etc. With these proposals, only the DNS resolver has visibility into the DNS messages.

### SUMMARY

End-to-end encryption is used for most user traffic carried by a 5G network, such that the UPF cannot identify traffic type directly from the user traffic. Moreover, the proposed encryption of DNS traffic also prevents UPF from identifying user traffic based on PFD domain names for DNS protocol or producing its own PFDs based on DNS traffic. This can cause various problems, issues, and/or difficulties for identifying and classifying application traffic, which is desirable and/or necessary for proper operation of a 5G network.

Embodiments of the present disclosure address these and other problems, issues, and/or difficulties, thereby facilitating proper operation of communication networks (e.g., 5G networks) even when DNS traffic is encrypted.

Some embodiments include exemplary methods (e.g., procedures) for an NWDAF configured to assist with application detection in a communication network (e.g., 5GC).

These exemplary methods can include receiving, from a consumer network function (cNF) of the communication network, an analytic request related to assisted application detection. These exemplary methods can also include, based on the analytic request, sending to a first DNS resolver associated with the communication network an exposure request for events related to fully qualified domain name (FQDN)-to-address mapping for application servers associated with applications. These exemplary methods can also include receiving from the first DNS resolver a first FQDN associated with a first application, in accordance with the exposure request. These exemplary methods can also include, based on the first FQDN, determining one or more PFDs associated with the first application and sending to the cNF an analytic result comprising the one or more PFDs, in accordance with the analytic request.

In some embodiments the cNF is a network exposure function (NEF), or a unit or sub-function thereof (e.g., a PFDF).

In some embodiments, the analytic request includes one or more of the following parameters that define a filter for the requested analytic: area of interest (AOI), single network slice selection assistance information (S-NSSAI), and data network name (DNN). In some of these embodiments, these exemplary methods can also include sending to a network repository function (NRF) of the communication network a discovery request for DNS resolvers associated with the communication network. The discovery request includes the one or more parameters that define the filter for the requested analytic. In some variants, these exemplary methods can also include, in response to the discovery request, receiving from the NRF an identifier of the first DNS resolver and a profile for the first DNS resolver. In such case, sending the exposure request to the first DNS resolver is based on at least one of the identifier and the profile received.

In some embodiments, determining the one or more PFDs based on the first FQDN includes determining an application identifier that corresponds to the first FQDN and selecting the one or more PFDs based on their association with the application identifier. In some of these embodiments, determining an application identifier that corresponds to the first FQDN includes sending the first FDQN to a network exposure function (NEF) of the communication network and receiving from the NEF a response including the application identifier.

Other embodiments include methods (e.g., procedures) for a DNS resolver configured to assist with application detection in a communication network (e.g., 5GC).

These exemplary methods can include receiving, from an NWDAF of the communication network, an exposure request for events related to FQDN-to-address mapping for application servers associated with applications. These exemplary methods can also include subsequently mapping a first FQDN to an address for an application server associated with a first application (e.g., based a DNS request from an application client). These exemplary methods can also include sending the first FQDN to the NWDAF in accordance with the exposure request.

In some embodiments, these exemplary methods can also include sending to an NRF of the communication network a request to register capabilities of the DNS resolver. The exposure request is received based on the registering of capabilities. In some embodiments, the request to register capabilities of the DNS resolver is an Nnrf_Registration Request message that includes the following information:
an identifier of the DNS resolver (DNS-ID);
an indication of DNS resolver support for exposure of events related to FQDN-to-address mapping; and
configuration information for the DNS resolver, including one or more of the following: area of interest (AOI), single network slice selection assistance information (S-NSSAI), and data network name (DNN).

Other embodiments include NWDAFs and DNS resolvers (or network nodes hosting the same) that are configured to perform the operations corresponding to exemplary methods described herein. Other embodiments also include non-transitory, computer-readable media storing computer-executable instructions that, when executed by processing circuitry, configure such NWDAFs and DNS resolvers to perform operations corresponding to exemplary methods described herein.

Other embodiments include a communication network (e.g., 5GC) comprising an NWDAF and a network repository function (NRF). The NRF is configured to receive, from a first DNS resolver associated with the communication network, a request to register capabilities of the first DNS resolver and store the first DNS resolver's capabilities in a profile for the first DNS resolver, in accordance with the request. The NRF is further configured to receive, from the NWDAF, a discovery request for DNS resolvers associated with the communication network. The discovery request includes one or more parameters that define an analytic filter. The NRF is further configured to determine that the stored capabilities of the first DNS resolver match the one or more parameters included in the discovery request and send to the NWDAF a discovery response that includes an identifier of the first DNS resolver and the profile for the first DNS resolver.

In some embodiments, the communication network can also include a consumer network function (cNF) configured to send, to the NWDAF, an analytic request related to assisted application detection and receive from the NWDAF an analytic result comprising one or more packet flow descriptions (PFDs) associated with a first application, in accordance with the analytic request. For example, the discovery request received by the NRF is based on the analytic request sent by the cNF, and the analytic request includes the one or more parameters that define the analytic filter.

In some embodiments, the communication network can also include a unified data unified data repository (UDR). The cNF is further configured to send the one or more PFDs associated with the first application to UDR for storage, and the UDR is configured to store the received one or more PFDs as application data for the first application. In some embodiments, the communication network can also include the first DNS resolver.

These and other embodiments described herein can enable a communication network (e.g., 5G network) to properly classify encrypted UE application traffic, including encrypted DNS traffic. Furthermore, embodiments can enable these operations without requiring an application service provider (ASP) to install and/or maintain associated PFDs in NEF or similar network repository. Additionally, embodiments can enable ASPs to define less complex PFDs based on domain name rather than IP address, even when encrypted DNS is used.

These and other objects, features, and advantages of the present disclosure will become apparent upon reading the following Detailed Description in view of the Drawings briefly described below.

### BRIEF DESCRIPTION OF THE DRAWINGS

FIGS. 1-2 illustrate various aspects of an exemplary 5G network architecture.

FIG. 3 (which includes FIGS. 3A-C) shows an exemplary procedure among various entities operating in a communication network, according to various embodiments of the present disclosure.

FIG. 4 shows an exemplary method (e.g., procedure) for an NWDAF of a communication network, according to various embodiments of the present disclosure.

FIG. 5 shows an exemplary method (e.g., procedure) for a DNS resolver associated with a communication network, according to various embodiments of the present disclosure.

FIG. 6 shows an exemplary method (e.g., procedure) for a consumer network function (cNF) of a communication network, according to various embodiments of the present disclosure. FIG. 7 shows an exemplary method (e.g., procedure) for an NRF of a communication network, according to various embodiments of the present disclosure.

FIG. 8 shows an exemplary method (e.g., procedure) for a UDR of a communication network, according to various embodiments of the present disclosure.

FIG. 9 shows a communication system according to various embodiments of the present disclosure.

FIG. 10 shows a UE according to various embodiments of the present disclosure.

FIG. 11 shows a network node according to various embodiments of the present disclosure.

FIG. 12 shows host computing system according to various embodiments of the present disclosure.

FIG. 13 is a block diagram of a virtualization environment in which functions implemented by some embodiments of the present disclosure may be virtualized.

FIG. 14 illustrates communication between a host computing system, a network node, and a UE via multiple connections, according to various embodiments of the present disclosure.

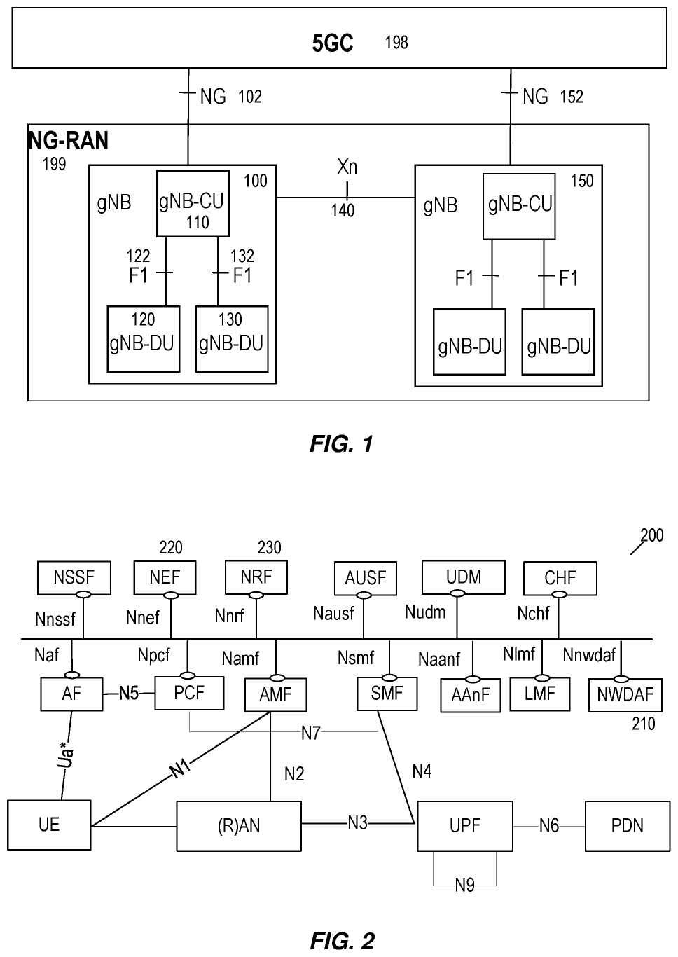

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features and advantages of the disclosed embodiments will be apparent from the following description.

Furthermore, the following terms are used throughout the description given below:
Core Network Node: As used herein, a “core network node” is any type of node in a core network. Some examples of a core network node include, e.g., a Mobility Management Entity (MME), a serving gateway (SGW), a Packet Data Network Gateway (P-GW), etc. A core network node can also be a node that implements a particular core network function (NF), such as an access and mobility management function (AMF), a session management function (AMF), a user plane function (UPF), a Service Capability Exposure Function (SCEF), or the like.
Network Node: As used herein, a “network node” is any node that is part of the core network (e.g., a core network node discussed above) of a telecommunications network. Functionally, a network node is equipment capable, configured, arranged, and/or operable to communicate directly or indirectly with a wireless or wired device and/or with other network nodes or equipment in the telecommunications network, to enable and/or provide wireless or wired access to the telecommunication device, and/or to perform other functions (e.g., administration) in the telecommunications network.
Node: As used herein, the term “node” (without any prefix) can be any type of node that is capable of operating in or with a telecommunication network (including a RAN and/or a core network), including a radio access node (or equivalent term), core network node, or telecommunications device.
Service: As used herein, the term “service” refers generally to a set of data, associated with one or more applications, which is to be transferred via a network with certain specific delivery requirements that need to be fulfilled in order to make the applications successful.
Component: As used herein, the term “component” refers generally to any component needed for the delivery of a service. Examples of component are RANs (e.g., E-UTRAN, NG-RAN, or portions thereof such as eNBs, gNBs, base stations (BS), etc.), CNs (e.g., EPC, 5GC, or portions thereof, including all type of links between RAN and CN entities), and cloud infrastructure with related resources such as computation, storage. In general, each component can have a “manager”, which is an entity that can collect historical information about utilization of resources as well as provide information about the current and the predicted future availability of resources associated with that component (e.g., a RAN manager).

Note that the description given herein focuses on a 3GPP telecommunications system and, as such, 3GPP terminology or terminology similar to 3GPP terminology is generally used. However, the concepts disclosed herein are not limited to a 3GPP system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from the concepts, principles, and/or embodiments described herein.

In addition, functions and/or operations described herein as being performed by a telecommunications device or a network node may be distributed over a plurality of telecommunications devices and/or network nodes.

FIG. 2 shows an exemplary non-roaming reference architecture for 5GC (200) with service-based interfaces and various 3GPP-defined NFs within the Control Plane (CP), including the following NFs:
Application Function (AF, with Naf interface) interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.
Policy Control Function (PCF, with Npcf interface) supports unified policy framework to govern the network behavior, via providing PCC rules (e.g., on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.
User Plane Function (UPF) supports handling of user plane traffic based on the rules received from SMF, including packet inspection and different enforcement actions (e.g., event detection and reporting). UPFs communicate with the RAN (e.g., NG-RAN) via the N3 reference point, with SMFs (discussed below) via the N4 reference point, and with an external packet data network (PDN) via the N6 reference point. The N9 reference point is for communication between two UPFs.
Session Management Function (SMF, with Nsmf interface) interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.
Charging Function (CHF, with Nchf interface) is responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems.
Access and Mobility Management Function (AMF, with Namf interface) terminates the RAN CP interface and handles all mobility and connection management of UEs (similar to MME in EPC). AMFs communicate with UEs via the N1 reference point and with the RAN (e.g., NG-RAN) via the N2 reference point.
Network Exposure Function (NEF, 220) with Nnef interface—acts as the entry point into operator's network, by securely exposing 5GC capabilities and events to AFs within and outside of the 5GC and by providing ways for the AF to securely provide information to 3GPP network. For example, NEF provides a service that allows an AF to provision specific subscription data (e.g., expected UE behavior) for various UEs.
Network Repository Function (NRF, 230) with Nnrf interface—provides service registration and discovery, enabling NFs to identify appropriate services available from other NFs.
Network Slice Selection Function (NSSF) with Nnssf interface—a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice. The NSSF enables other NFs (e.g., AMF) to identify a network slice instance that is appropriate for a UE's desired service.
Authentication Server Function (AUSF) with Nausf interface—based in a user's home network (HPLMN), it performs user authentication and computes security key materials for various purposes.
Network Data Analytics Function (NWDAF, 210) with Nnwdaf interface, described in more detail above and below.
Location Management Function (LMF) with NImf interface—supports various functions related to determination of UE locations, including location determination for a UE and obtaining any of the following: DL location measurements or a location estimate from the UE; UL location measurements from the NG RAN; and non-UE associated assistance data from the NG RAN.

The Unified Data Management (UDM) function supports generation of 3GPP authentication credentials, user identification handling, access authorization based on subscription data, and other subscriber-related functions. To provide this functionality, the UDM uses subscription data (including authentication data) stored in the 5GC unified data repository (UDR). In addition to the UDM, the UDR supports storage and retrieval of policy data by the PCF, as well as storage and retrieval of application data by NEF.

One additional function or capability of NEF is management of Packet Flow Descriptions (PFDs). A PFD is a set of information related to traffic associated with a particular application. Each PFD can be identified by a PFD ID, which is unique within the scope of a particular application identifier. However, an application identifier may be associated with multiple PFD types and corresponding PFD IDs.

3GPP TS 29.551 (v17.6.0) describes conditions under which a PFD ID is included in a PDF. In addition to PFD ID, a PFD can include one or more of the following:
3-tuple(s) including protocol, server side IP address, and port number;
significant parts of URL to be matched (e.g., host name); and
domain name matching criteria and information about applicable protocols (e.g., DNS).

The NEF may receive PFDs from AFs associated with respective applications. The PFD function (PFDF) of the NEF creates, updates, or removes PFDs in the NEF and distributes PFDs to UPF via SMF. In particular, SMF receives a PFD from NEF and converts it to applications and filters in packet detection rules (PDRs), which are sent to UPF. These features may be used when the UPF is configured to detect a particular application provided by an application service provider (ASP).

As mentioned above, 3GPP TS 23.288 (v17.2.0) specifies that NWDAF is the main network function for computing analytic reports. The 5G system architecture allows any NF to obtain analytics from an NWDAF using a data collection coordination function (DCCF) and associated Ndccf services. The NWDAF can also perform.
data collection based on event subscription, provided by AMF, SMF, PCF, UDM, AF (directly or via NEF), and operations/administration/maintenance (OAM);
retrieval of information from data repositories (e.g., UDR via UDM for subscriber-related information, analytics data repository function (ADRF) for analytics-related information);
storage of analytics information in ADRF;
retrieval of NF-related information (e.g., from NRF and/or NSSF); and
on-demand provisioning of analytics to consumers.

DNS is a fundamental Internet building block that is used when a user visits a website, sends an email, has an IM conversation, or does almost anything else online. When a user opens an application, a DNS client retrieves server IP address(es) for the application domain from a DNS resolver. Currently most DNS traffic today is sent unencrypted over UDP/TCP, but there are different IETF drafts proposing DNS encryption to prevent reading of DNS traffic in the middle between endpoints. Various proposals include DNS over HTTP/2 (DOH), DNS over TLS, DNSCrypt, etc. With these proposals, only the DNS resolver has visibility into the DNS messages.

End-to-end encryption is used for most user traffic carried by a 5G network, such that the UPF cannot identify traffic type directly from the user traffic. There has been some discussion of a 3GPP Rel-18 enhancement for NWDAF-assisted application detection, where the NWDAF detects new PFDs using UPF data. Moreover, the proposed encryption of DNS traffic also prevents UPF from identifying user traffic based on PFD domain names for DNS protocol or producing its own PFDs based on DNS traffic. Moreover, the proposed encryption of DNS traffic also hinders NWDAF-assisted application detection of new PFDs using UPF data.

Accordingly, embodiments of the present disclosure address these and other problems, issues, and/or difficulties by extending NWDAF-assisted application detection to include data collected from a DNS resolver, thereby facilitating NWDAF derivation of PFDs to detect application traffic.

Embodiments can be summarized at a high level as follows. A DNS resolver registers its capabilities in NRF, using a new Event Exposure service. The consumer (e.g., NEF) requests or subscribes to NWDAF for an analytic ID for Assisted Classification Detection by triggering an Nnwdaf_AnalyticsSubscription_Request service operation or an Nnwdaf_AnalyticsInfo_Request service operation, respectively. The NWDAF discovers the DNS Resolver instance(s) based on the analytic request and triggers data collection from the DNS Resolver instance(s) relative to a new event on fully qualified domain name (FQDN or QNAME)-to-server IP address mapping. If needed, the NWDAF may trigger data collection from NEF to obtain the Application Identifier for the FQDN.

Based on the data collected, the NWDAF runs analytic processes, derives PFDs, and provides them to the consumer (e.g., NEF) as requested or subscribed. The consumer stores the derived PFDs in the UDR, e.g., as Application Data. The derived PFDs are then distributed to the UPFs to match incoming traffic.

Embodiments can provide various benefits and/or advantages. For example, embodiments can enable a communication network (e.g., 5G network) to properly classify encrypted UE application traffic, including encrypted DNS traffic. Furthermore, embodiments can enable these operations without requiring an application service provider (ASP) to install and/or maintain associated PFDs in the NEF or similar repository. Additionally, embodiments can enable ASPs to define less complex PFDs based on domain name rather than IP address, even when encrypted DNS is used.

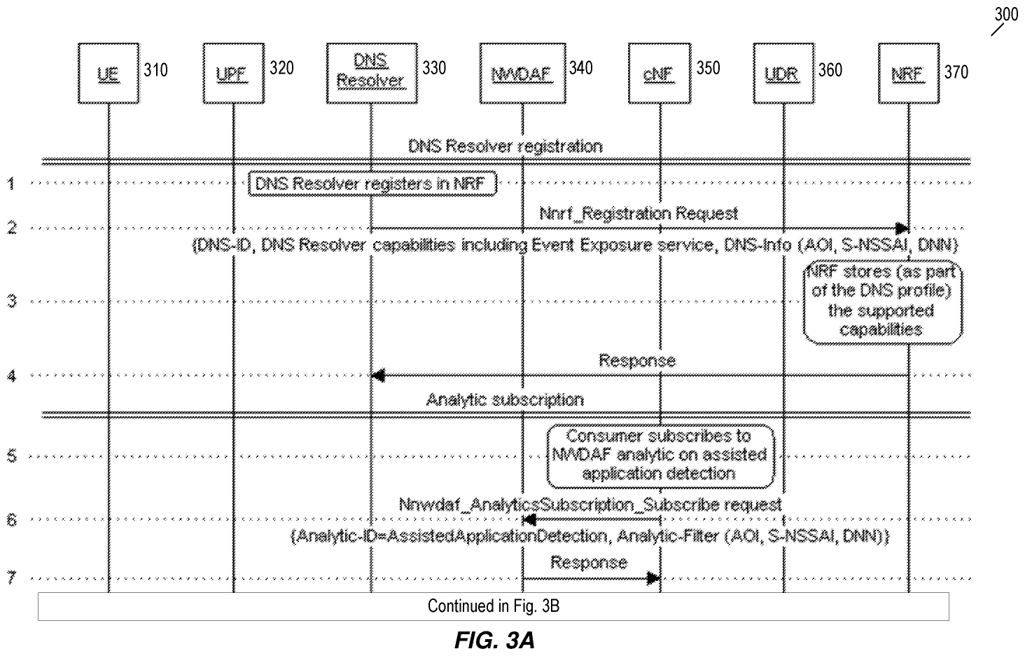

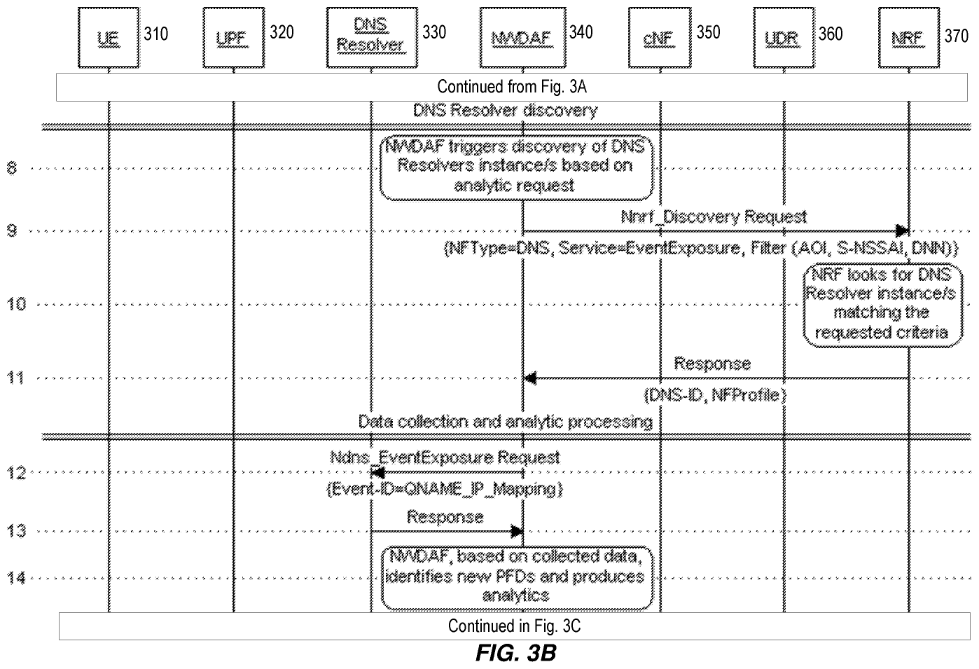

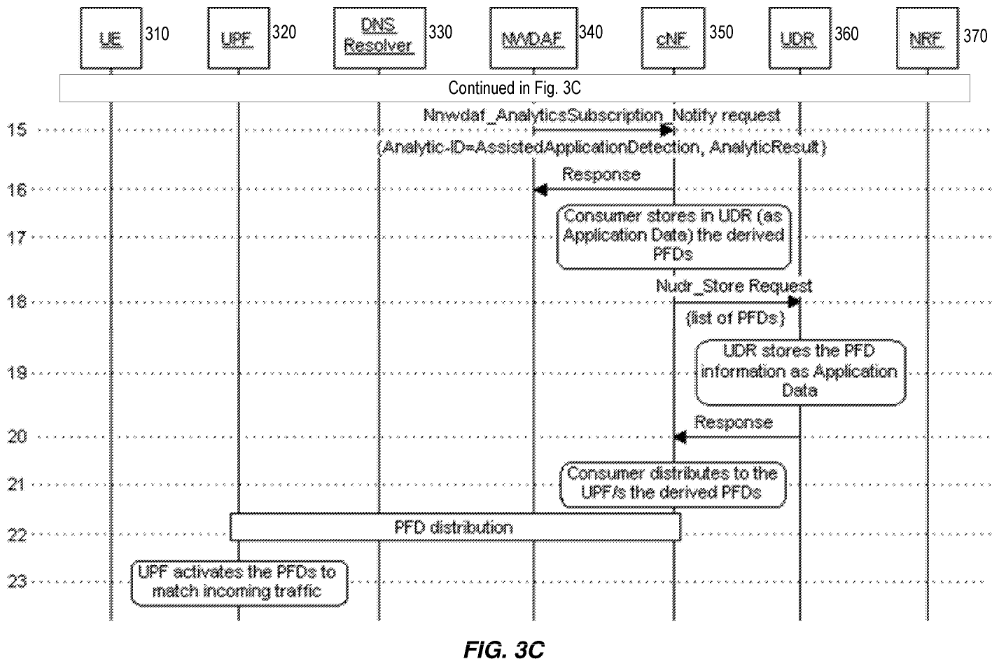

FIG. 3 (which includes FIGS. 3A-C) shows an exemplary procedure among various entities operating in a communication network (300), according to various embodiments of the present disclosure. In particular, the exemplary procedure is between a UE (310), a UPF (320), a DNS resolver (330), an NWDAF (340), a consumer NF (cNF, 350), a UDR (360) and an NRF (370). Although the operations of the procedure are given numerical labels, this is intended to facilitate explanation rather than to require or imply any particular sequential order, unless expressly stated to the contrary.

In operations 1-2, the DNS resolver registers in NRF by sending an Nnrf_Registration Request message that includes the following information:
DNS resolver instance identifier (DNS-ID);
DNS resolver instance capabilities, including Event Exposure service; and
DNS resolver instance configuration information, such as area of interest (AOI), single network slice selection assistance information (S-NSSAI), data network name (DNN), etc. In operations 3-4, the NRF stores the information received in operation 2 as part of the NFprofile for DNS and responds to the DNS resolver indicating successful operation.

In operations 5-6, the cNF (e.g., NEF/PFDF acting as cNF) subscribes to an NWDAF analytic for assisted application detection (e.g., Analytic-ID=AssistedApplicationDetection) by sending an Nnwdaf_AnalyticsSubscription_Subscribe Request message including parameters (e.g., AOI, S-NSSAI, DNN) that represent an Analytic-Filter. In operation 7, NWDAF responds to the cNF indicating successful operation.

The analytic request sent/received in operation 6 triggers a data collection process in NWDAF, which determines what data is required and whether the required data is already available or needs to be collected. In embodiments of the present disclosure, the data to be collected (if not already available) includes data from the DNS resolver.

In operations 8-11, NWDAF discovers contact information for the DNS entities from which it needs to collect data. In particular, the NWDAF sends a Nnrf_Discovery Request message identifying DNS as NFtype of interesting and include filter parameters such as those received from the cNF in operation 6. The NRF looks for registered DNS resolver instances that match the filter parameters and sends a response with identities (DNS-ID) and profile information (NFprofile) for the selected DNS resolver instances. In general, operations 8-11 can use conventional NRF discovery services.

Based on the received NFprofile, in operation 12 the NWDAF triggers data collection from the DNS Resolver by sending an Ndns_EventExposure Request message including a requested event, i.e., Event-ID=QNAME_IP_Mapping. In operation 13, the DNS Resolver sends a response indicating successful operation.

In operation 14, based on the collected data, the NWDAF identifies new PFDs and produces analytics results. PFDs are defined per Application Identifier. The relations or mapping between Application Identifiers and FQDNs in DNS event notifications may have been locally configured in NWDAF. Alternately, this information may be available in NEF as provided by AF, locally configured PFDs, or edge application server (EAS) deployment information as described in 3GPP TS 23.548 (v17.3.0). This analytic is enhanced to use data from NEF from that purpose.

In case the relations between Application Identifiers and FQDNs are available in NEF, the NWDAF selects relevant NEF(s) to be contacted and performs data collection from the selected NEF(s) using existing NEF services for PFD and EAS Deployment information retrieval. The NWDAF then uses the information collected from NEF together with the event information collected from DNS to identify new PFDs and produce analytics in operation 14.

In operation 15, NWDAF sends an Nnwdaf_AnalyticsSubscription_Notify Request message to cNF (e.g., NEF/PFDF) including the identified PFDs as an analytic result. In operation 16, cNF responds to NWDAF indicating successful operation.

In operations 17-18, cNF (e.g., NEF/PFDF) sends UDR an Nudr_Store Request message including the PFDs received from NWDAF. In operation 19, the UDR stores the received information as an extension to an existing Application Data structure. In operation 20, the UDR responds to cNF indicating successful operation. In operations 21-22, cNF (e.g., NEF/PFDF) distributes the derived PFDs to the UPF. In operation 23, the UPF activates the received PFDs to match incoming traffic.

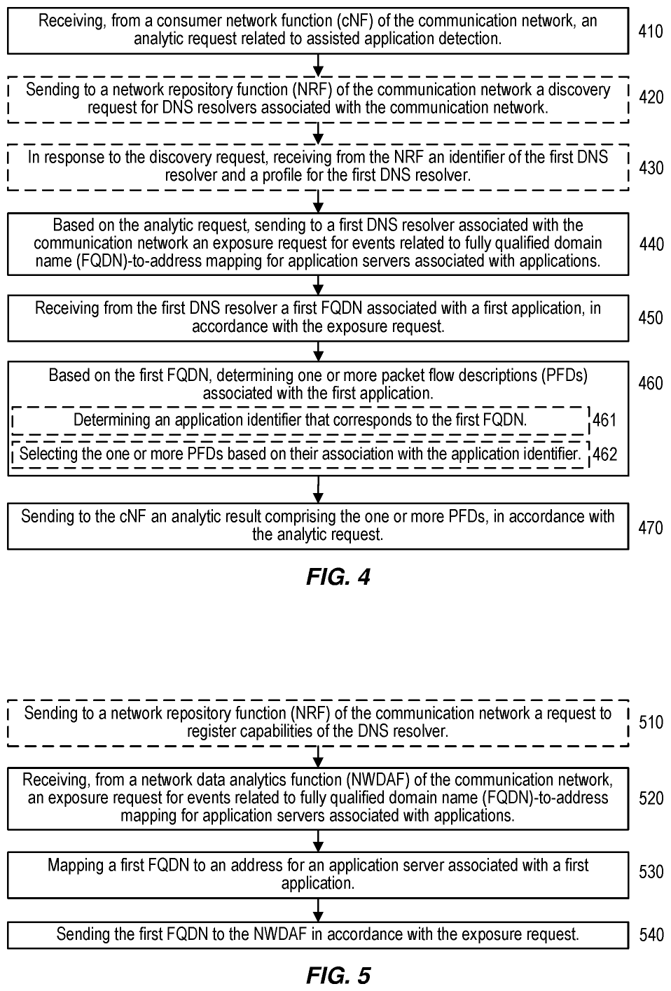

The embodiments described above can be further illustrated with reference to FIGS. 4-8, which depict exemplary methods (e.g., procedures) for an NWDAF, a DNS resolver, an NEF, an NRF, and a UDR, respectively. Put differently, various features of the operations described below correspond to various embodiments described above. The exemplary methods shown in FIGS. 4-8 can be used cooperatively (e.g., with each other and with other procedures described herein) to provide benefits, advantages, and/or solutions to problems described herein. Although the exemplary methods are illustrated in FIGS. 4-8 by specific blocks in particular orders, the operations corresponding to the blocks can be performed in different orders than shown and can be combined and/or divided into blocks and/or operations having different functionality than shown. Optional blocks and/or operations are indicated by dashed lines.

In particular, FIG. 4 illustrates an exemplary method (e.g., procedure) for an NWDAF configured to assist with application detection in a communication network (e.g., 5GC), according to various embodiments of the present disclosure. For example, the exemplary method shown in FIG. 4 can be performed by an NWDAF or a network node hosting an NWDAF, such as described elsewhere herein.

The exemplary method can include the operations of block 410, where the NWDAF can receive, from a consumer network function (cNF) of the communication network, an analytic request related to assisted application detection. The exemplary method can also include the operations of block 440, where based on the analytic request, the NWDAF can send to a first DNS resolver associated with the communication network an exposure request for events related to FQDN-to-address mapping for application servers associated with applications. The exemplary method can also include the operations of block 450, where the NWDAF can receive from the first DNS resolver a first FQDN associated with a first application, in accordance with the exposure request. The exemplary method can also include the operations of block 460, where based on the first FQDN, the NWDAF can determine one or more packet flow descriptions (PFDs) associated with the first application. The exemplary method can also include the operations of block 470, where the NWDAF can send to the cNF an analytic result comprising the one or more PFDs, in accordance with the analytic request.

In some embodiments the cNF is a network exposure function (NEF), or a unit or sub-function thereof (e.g., a PFDF).

In some embodiments, the analytic request (e.g., in block 410) includes one or more of the following parameters that define a filter for the requested analytic: area of interest (AOI), single network slice selection assistance information (S-NSSAI), and data network name (DNN). In some of these embodiments, the exemplary method can also include the operations of block 420, where the NWDAF can send to an NRF of the communication network a discovery request for DNS resolvers associated with the communication network. The discovery request includes the one or more parameters that define the filter for the requested analytic. In some variants, the exemplary method can also include the operations of block 430, where in response to the discovery request, the NWDAF can receive from the NRF an identifier of the first DNS resolver and a profile for the first DNS resolver. In such case, sending the exposure request to the first DNS resolver (e.g., in block 440) is based on at least one of the identifier and the profile received in block 430.

In some embodiments, determining the one or more PFDs based on the first FQDN in block 460 includes the operations of sub-blocks 461-462, where the NWDAF can determine an application identifier that corresponds to the first FQDN and select the one or more PFDs based on their association with the application identifier. In some of these embodiments, determining an application identifier that corresponds to the first FQDN in sub-block 461 includes sending the first FDQN to an NEF of the communication network and receiving from the NEF a response that includes the application identifier.

In addition, FIG. 5 illustrates an exemplary method (e.g., procedure) for a DNS resolver configured to assist with application detection in a communication network (e.g., 5GC), according to various embodiments of the present disclosure. For example, the exemplary method shown in FIG. 5 can be performed by a DNS resolver function or a network node hosting a DNS resolver, such as described elsewhere herein.

The exemplary method can include the operations of block 520, where the DNS resolver can receive, from an NWDAF of the communication network, an exposure request for events related to FQDN-to-address mapping for application servers associated with applications. The exemplary method can also include the operations of block 530, where the DNS resolver can subsequently map a first FQDN to an address for an application server associated with a first application (e.g., based a DNS request from an application client). The exemplary method can also include the operations of block 540, where the DNS resolver can send the first FQDN to the NWDAF in accordance with the exposure request.

In some embodiments, the exemplary method can also include the operations of block 510, where the DNS resolver can send to an NRF of the communication network a request to register capabilities of the DNS resolver. The exposure request is received in block 520 based on the registering of capabilities. In some embodiments, the request to register capabilities of the DNS resolver is an Nnrf_Registration Request message that includes the following information:
an identifier of the DNS resolver (DNS-ID);
an indication of DNS resolver support for exposure of events related to FQDN-to-address mapping; and
configuration information for the DNS resolver, including one or more of the following: area of interest (AOI), single network slice selection assistance information (S-NSSAI), and data network name (DNN).

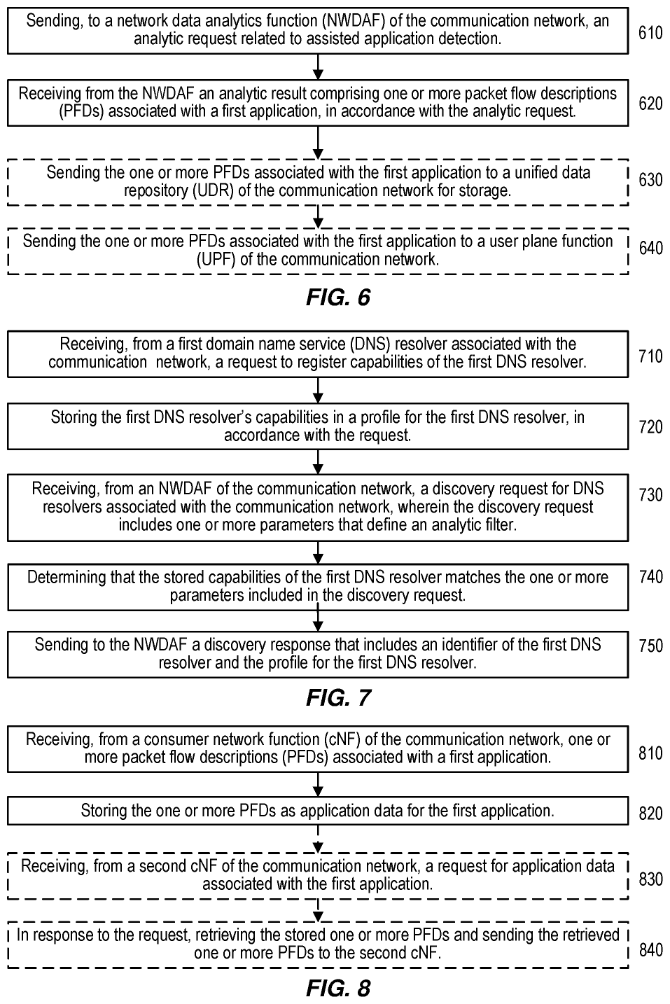

In addition, FIG. 6 illustrates an exemplary method (e.g., procedure) for a consumer network function (cNF) of a communication network (e.g., 5GC), according to various embodiments of the present disclosure. For example, the exemplary method shown in FIG. 6 can be performed by any appropriate cNF or a network node hosting such a cNF, such as described elsewhere herein.

The exemplary method can include the operations of block 610, where the cNF can send, to an NWDAF of the communication network, an analytic request related to assisted application detection. The exemplary method can also include the operations of block 620, where the cNF can receive from the NWDAF an analytic result comprising one or more PFDs associated with a first application, in accordance with the analytic request.

In some embodiments the cNF is a network exposure function (NEF), or a unit or sub-function thereof (e.g., a PFDF).

In some embodiments, the exemplary method can also include the operations of block 630, where the cNF can send the one or more PFDs associated with the first application to a unified data repository (UDR) of the communication network for storage. In some embodiments, the exemplary method can also include the operations of block 640, where the cNF can send the one or more PFDs associated with the first application to a user plane function (UPF) of the communication network.

In some embodiments, the analytic request (e.g., in block 610) includes one or more of the following parameters that define a filter for the requested analytic: AOI, S-NSSAI, and DNN.

In addition, FIG. 7 illustrates an exemplary method (e.g., procedure) for an NRF of a communication network (e.g., 5GC), according to various embodiments of the present disclosure. For example, the exemplary method shown in FIG. 7 can be performed by an NRF or a network node hosting an NRF, such as described elsewhere herein.

The exemplary method can include the operations of block 710, where the NRF can receive, from a first DNS resolver associated with the communication network, a request to register capabilities of the first DNS resolver. The exemplary method can also include the operations of block 720, where the NRF can store the first DNS resolver's capabilities in a profile for the first DNS resolver, in accordance with the request. The exemplary method can also include the operations of block 730, where the NRF can receive, from an NWDAF of the communication network, a discovery request for DNS resolvers associated with the communication network. The discovery request includes one or more parameters that define an analytic filter. The exemplary method can also include the operations of block 740, where the NRF can determine that the stored capabilities of the first DNS resolver matches the one or more parameters included in the discovery request. The exemplary method can also include the operations of block 750, where the NRF can send to the NWDAF a discovery response that includes an identifier of the first DNS resolver and the profile for the first DNS resolver.

In some embodiments, the request to register capabilities of the first DNS resolver is an Nnrf_Registration Request message that includes the following information:
an identifier of the first DNS resolver (DNS-ID);
an indication of first DNS resolver support for exposure of events related to FQDN-to-address mapping; and
configuration information for the first DNS resolver, including one or more of the following: AOI, S-NSSAI, and DNN.

In addition, FIG. 8 illustrates an exemplary method (e.g., procedure) for a UDR of a communication network (e.g., 5GC), according to various embodiments of the present disclosure. For example, the exemplary method shown in FIG. 8 can be performed by an UDR or a network node hosting a UDR, such as described elsewhere herein.

The exemplary method can include the operations of block 810, where the UDR can receive, from a cNF of the communication network, one or more PFDs associated with a first application. The exemplary method can also include the operations of block 820, where the UDR can store the one or more PFDs as application data for the first application.

In some embodiments the cNF is a network exposure function (NEF), or a unit or sub-function thereof (e.g., a PFDF).

In some embodiments, the exemplary method can also include the operations of blocks 830-840, where the UDR can receive from a second cNF of the communication network a request for application data associated with the first application and in response to the request, retrieve the stored one or more PFDs and send the retrieved one or more PFDs to the second cNF.

Although various embodiments are described herein above in terms of methods, apparatus, devices, computer-readable medium and receivers, the person of ordinary skill will readily comprehend that such methods can be embodied by various combinations of hardware and software in various communication networks, communication devices, computing devices, control devices, apparatuses, non-transitory computer-readable media, etc.

For example, embodiments include a communication network comprising an NWDAF and an NRF, with the NRF being configured to perform operations corresponding to the exemplary method described above in relation to FIG. 7. In some embodiments, the communication network can also include the first DNS resolver with which the NRF communicates. In some embodiments, the communication network can also include a cNF (e.g., NEF or sub-function thereof, such as PFDF) configured to perform operations corresponding to the exemplary method described above in relation to FIG. 6. In some embodiments, the communication network can also include a UDR configured to perform operations corresponding to the exemplary method described above in relation to FIG. 8. FIG. 3 shows a more specific example of a communication network comprising NFs configured in this manner.

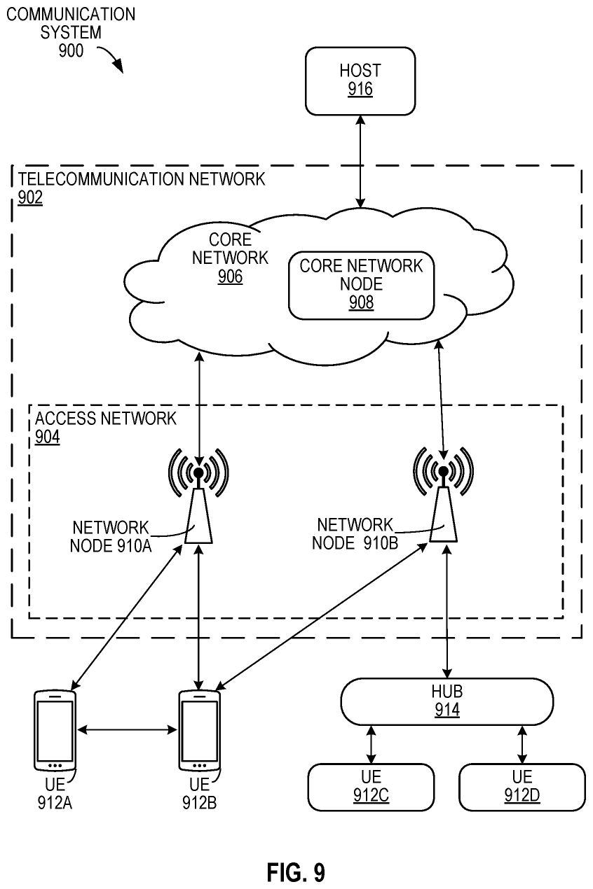

As another example, FIG. 9 shows a communication system 900 in accordance with some embodiments. The communication system 900 includes a telecommunication network 902 that includes an access network 904, such as a radio access network (RAN), and a core network 906, which includes one or more core network nodes 908. The access network 904 includes one or more access network nodes, such as network nodes 910a and 910b (one or more of which may be generally referred to as network nodes 910), or any other similar 3GPP access node or non-3GPP access point. The network nodes 910 facilitate direct or indirect connection of UEs, such as by connecting UEs 912a, 912b, 912c, and 912d (one or more of which may be generally referred to as UEs 912) to the core network 906 over one or more wireless connections.

As a specific example, one or more core network nodes 908 can be configured to perform operations attributed to an NWDAF, an NRF, a cNF, a UDR, and/or a DNS resolver in the descriptions herein of various methods or procedures.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The UEs 912 may be any of a wide variety of communication devices, including wireless devices arranged, configured, and/or operable to communicate wirelessly with the network nodes 910 and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes (e.g., core network node 908) that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902, and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a specific example, host 916 can be configured to perform operations attributed to a DNS resolver in the descriptions herein of various methods or procedures.

As a whole, the communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single-or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 914 communicates with the access network 904 to facilitate indirect communication between one or more UEs (e.g., UE 912c and/or 912d) and network nodes (e.g., network node 910b). In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910b. The hub 914 may also allow for a different communication scheme and/or schedule between the hub 914 and UEs (e.g., UE 912c and/or 912d), and between the hub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub-that is, a hub whose primary function is to route communications to/from the UEs from/to the network node 910b. In other embodiments, the hub 914 may be a non-dedicated hub-that is, a device which is capable of operating to route communications between the UEs and network node 910b, but which is additionally capable of operating as a communication start and/or end point for certain data channels.

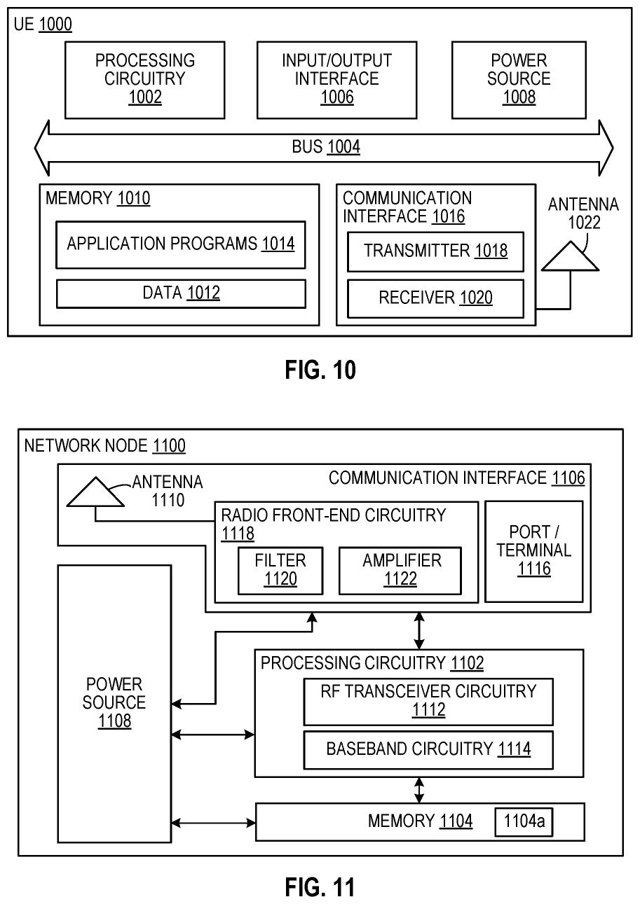

FIG. 10 shows a UE 1000 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1000 includes processing circuitry 1002 that is operatively coupled via a bus 1004 to an input/output interface 1006, a power source 1008, a memory 1010, a communication interface 1012, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 1002 is configured to process instructions and data and may be configured to implement any sequential state machine operative to execute instructions stored as machine-readable computer programs in the memory 1010. The processing circuitry 1002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1002 may include multiple central processing units (CPUs).

In the example, the input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1008 is structured as a battery or battery pack. Other types of power sources, such as an external power source (e.g., an electricity outlet), photovoltaic device, or power cell, may be used. The power source 1008 may further include power circuitry for delivering power from the power source 1008 itself, and/or an external power source, to the various parts of the UE 1000 via input circuitry or an interface such as an electrical power cable. Delivering power may be, for example, for charging of the power source 1008. Power circuitry may perform any formatting, converting, or other modification to the power from the power source 1008 to make the power suitable for the respective components of the UE 1000 to which power is supplied.

The memory 1010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1010 includes one or more application programs 1014, such as an operating system, web browser application, a widget, gadget engine, or other application, and corresponding data 1016. The memory 1010 may store, for use by the UE 1000, any of a variety of various operating systems or combinations of operating systems.

The memory 1010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1010 may allow the UE 1000 to access instructions, application programs and the like, stored on transitory or non-transitory memory media, to off-load data, or to upload data. An article of manufacture, such as one utilizing a communication system may be tangibly embodied as or in the memory 1010, which may be or comprise a device-readable storage medium.

The processing circuitry 1002 may be configured to communicate with an access network or other network using the communication interface 1012. The communication interface 1012 may comprise one or more communication subsystems and may include or be communicatively coupled to an antenna 1022. The communication interface 1012 may include one or more transceivers used to communicate, such as by communicating with one or more remote transceivers of another device capable of wireless communication (e.g., another UE or a network node in an access network). Each transceiver may include a transmitter 1018 and/or a receiver 1020 appropriate to provide network communications (e.g., optical, electrical, frequency allocations, and so forth). Moreover, the transmitter 1018 and receiver 1020 may be coupled to one or more antennas (e.g., antenna 1022) and may share circuit components, software or firmware, or alternatively be implemented separately.

In the illustrated embodiment, communication functions of the communication interface 1012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1000 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 11 shows a network node 1100 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1100 includes a processing circuitry 1102, a memory 1104, a communication interface 1106, and a power source 1108. The network node 1100 may be composed of multiple physically separate components (e.g., a NodeB component and a RNC component, or a BTS component and a BSC component, etc.), which may each have their own respective components. In certain scenarios in which the network node 1100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1100 may be configured to support multiple radio access technologies (RATs). In such embodiments, some components may be duplicated (e.g., separate memory 1104 for different RATs) and some components may be reused (e.g., a same antenna 1110 may be shared by different RATs). The network node 1100 may also include multiple sets of the various illustrated components for different wireless technologies integrated into network node 1100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1100.

The processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as the memory 1104, to provide network node 1100 functionality.

In some embodiments, the processing circuitry 1102 includes a system on a chip (SOC). In some embodiments, the processing circuitry 1102 includes one or more of radio frequency (RF) transceiver circuitry 1112 and baseband processing circuitry 1114. In some embodiments, the radio frequency (RF) transceiver circuitry 1112 and the baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

The memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions (collectively denoted computer program product 1104a) capable of being executed by the processing circuitry 1102 and utilized by the network node 1100. The memory 1104 may be used to store any calculations made by the processing circuitry 1102 and/or any data received via the communication interface 1106. In some embodiments, the processing circuitry 1102 and memory 1104 is integrated.

The communication interface 1106 is used in wired or wireless communication of signaling and/or data between a network node, access network, and/or UE. As illustrated, the communication interface 1106 comprises port(s)/terminal(s) 1116 to send and receive data, for example to and from a network over a wired connection. The communication interface 1106 also includes radio front-end circuitry 1118 that may be coupled to, or in certain embodiments a part of, the antenna 1110. Radio front-end circuitry 1118 comprises filters 1120 and amplifiers 1122. The radio front-end circuitry 1118 may be connected to an antenna 1110 and processing circuitry 1102. The radio front-end circuitry may be configured to condition signals communicated between antenna 1110 and processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of filters 1120 and/or amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface may comprise different components and/or different combinations of components.

In certain alternative embodiments, the network node 1100 does not include separate radio front-end circuitry 1118, instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes one or more ports or terminals 1116, the radio front-end circuitry 1118, and the RF transceiver circuitry 1112, as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the network node 1100 through an interface or port.

The antenna 1110, communication interface 1106, and/or the processing circuitry 1102 may be configured to perform any receiving operations and/or certain obtaining operations described herein as being performed by the network node. Any information, data and/or signals may be received from a UE, another network node and/or any other network equipment. Similarly, the antenna 1110, the communication interface 1106, and/or the processing circuitry 1102 may be configured to perform any transmitting operations described herein as being performed by the network node. Any information, data and/or signals may be transmitted to a UE, another network node and/or any other network equipment.

The power source 1108 provides power to the various components of network node 1100 in a form suitable for the respective components (e.g., at a voltage and current level needed for each respective component). The power source 1108 may further comprise, or be coupled to, power management circuitry to supply the components of the network node 1100 with power for performing the functionality described herein. For example, the network node 1100 may be connectable to an external power source (e.g., the power grid, an electricity outlet) via an input circuitry or interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the network node 1100 may include additional components beyond those shown in FIG. 11 for providing certain aspects of the network node's functionality, including any of the functionality described herein and/or any functionality necessary to support the subject matter described herein. For example, the network node 1100 may include user interface equipment to allow input of information into the network node 1100 and to allow output of information from the network node 1100. This may allow a user to perform diagnostic, maintenance, repair, and other administrative functions for the network node 1100.

As a specific example, one or more network nodes 1100 can be configured to perform operations attributed to an NWDAF, an NRF, a cNF, a UDR, and/or a DNS resolver in the descriptions herein of various methods or procedures.

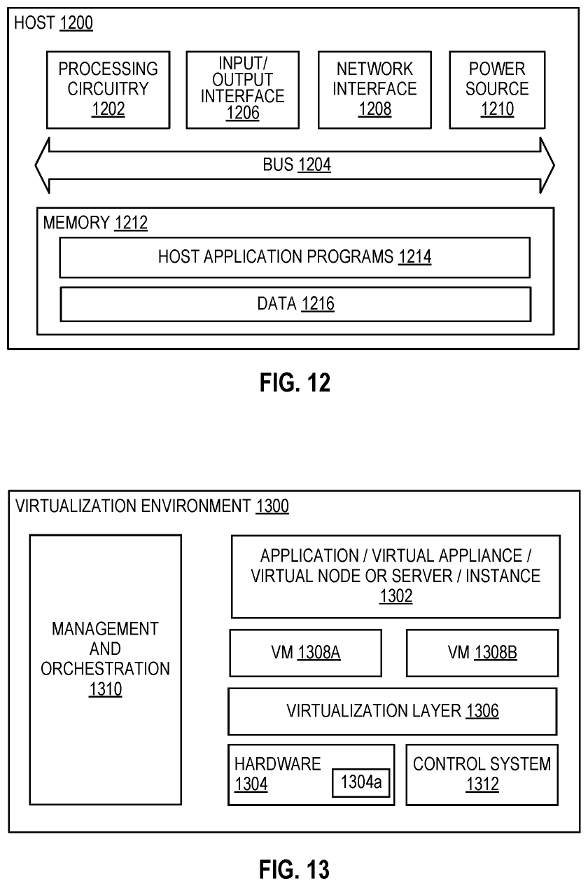

FIG. 12 is a block diagram of a host 1200, which may be an embodiment of the host 916 of FIG. 9, in accordance with various aspects described herein. As used herein, the host 1200 may be or comprise various combinations hardware and/or software, including a standalone server, a blade server, a cloud-implemented server, a distributed server, a virtual machine, container, or processing resources in a server farm. The host 1200 may provide one or more services to one or more UEs.

The host 1200 includes processing circuitry 1202 that is operatively coupled via a bus 1204 to an input/output interface 1206, a network interface 1208, a power source 1210, and a memory 1212. Other components may be included in other embodiments. Features of these components may be substantially similar to those described with respect to the devices of previous figures, such as FIGS. 10 and 11, such that the descriptions thereof are generally applicable to the corresponding components of host 1200.

The memory 1212 may include one or more computer programs including one or more host application programs 1214 and data 1216, which may include user data, e.g., data generated by a UE for the host 1200 or data generated by the host 1200 for a UE. Embodiments of the host 1200 may utilize only a subset or all of the components shown. The host application programs 1214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1214 may also provide for user authentication and licensing checks and may periodically report health, routes, and content availability to a central node, such as a device in or on the edge of a core network. Accordingly, the host 1200 may select and/or indicate a different host for over-the-top services for a UE. The host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

As a specific example, host 1200 can be configured to perform operations attributed to a DNS resolver in the descriptions herein of various methods or procedures.

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1302 (which may alternatively be called software instances, virtual appliances, network functions, virtual nodes, virtual network functions, etc.) are run in the virtualization environment 1200 to implement some of the features, functions, and/or benefits of some of the embodiments disclosed herein. As a specific example, an NWDAF, an NRF, a cNF, a UDR, and/or a DNS resolver, described herein in relation to other figures, can be implemented as virtual network functions 1902 in virtualization environment 1300.

Hardware 1304 includes processing circuitry, memory that stores software and/or instructions (collectively denoted computer program product 1304a) executable by hardware processing circuitry, and/or other hardware devices as described herein, such as a network interface, input/output interface, and so forth. Software may be executed by the processing circuitry to instantiate one or more virtualization layers 1306 (also referred to as hypervisors or virtual machine monitors (VMMs)), provide VMs 1308a and 1308b (one or more of which may be generally referred to as VMs 1308), and/or perform any of the functions, features and/or benefits described in relation with some embodiments described herein. The virtualization layer 1306 may present a virtual operating platform that appears like networking hardware to the VMs 1308.

The VMs 1308 comprise virtual processing, virtual memory, virtual networking or interface and virtual storage, and may be run by a corresponding virtualization layer 1306. Different embodiments of the instance of a virtual appliance 1302 may be implemented on one or more of VMs 1308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1308 may be a software implementation of a physical machine that runs programs as if they were executing on a physical, non-virtualized machine. Each of the VMs 1308, and that part of hardware 1304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1308 on top of the hardware 1304 and corresponds to the application 1302.

Hardware 1304 may be implemented in a standalone network node with generic or specific components. Hardware 1304 may implement some functions via virtualization. Alternatively, hardware 1304 may be part of a larger cluster of hardware (e.g., such as in a data center or CPE) where many hardware nodes work together and are managed via management and orchestration 1310, which, among others, oversees lifecycle management of applications 1302. In some embodiments, hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1312 which may alternatively be used for communication between hardware nodes and radio units.

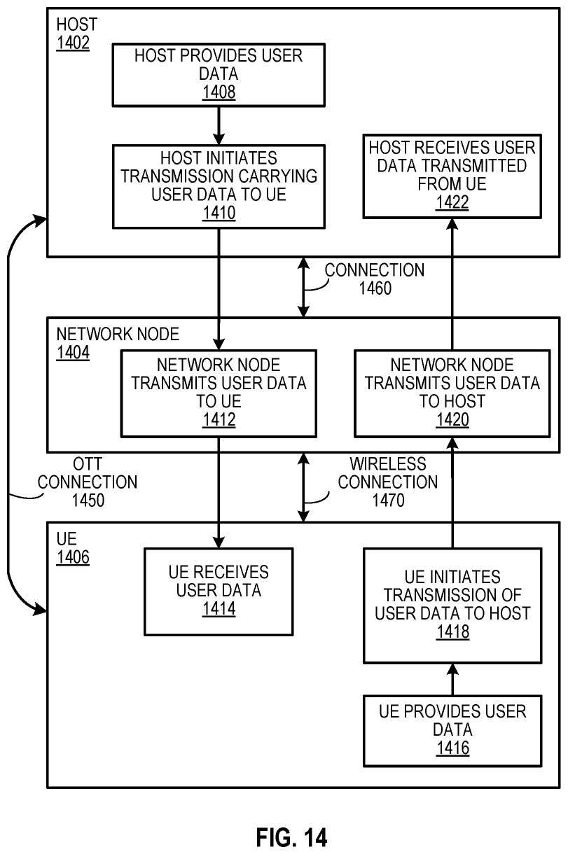

FIG. 14 shows a communication diagram of a host 1402 communicating via a network node 1404 with a UE 1406 over a partially wireless connection in accordance with some embodiments. Example implementations, in accordance with various embodiments, of the UE (such as a UE 912a of FIG. 9 and/or UE 1000 of FIG. 10), network node (such as network node 910a of FIG. 9 and/or network node 1100 of FIG. 11), and host (such as host 916 of FIG. 9 and/or host 1200 of FIG. 12) discussed in the preceding paragraphs will now be described with reference to FIG. 14.

Like host 1200, embodiments of host 1402 include hardware, such as a communication interface, processing circuitry, and memory. The host 1402 also includes software, which is stored in or accessible by the host 1402 and executable by the processing circuitry. The software includes a host application that may be operable to provide a service to a remote user, such as the UE 1406 connecting via an over-the-top (OTT) connection 1450 extending between the UE 1406 and host 1402. In providing the service to the remote user, a host application may provide user data which is transmitted using the OTT connection 1450.

The network node 1404 includes hardware enabling it to communicate with the host 1402 and UE 1406. The connection 1460 may be direct or pass through a core network (like core network 906 of FIG. 9) and/or one or more other intermediate networks, such as one or more public, private, or hosted networks. For example, an intermediate network may be a backbone network or the Internet.

The UE 1406 includes hardware and software, which is stored in or accessible by UE 1406 and executable by the UE's processing circuitry. The software includes a client application, such as a web browser or operator-specific “app” that may be operable to provide a service to a human or non-human user via UE 1406 with the support of the host 1402. In the host 1402, an executing host application may communicate with the executing client application via the OTT connection 1450 terminating at the UE 1406 and host 1402. In providing the service to the user, the UE's client application may receive request data from the host's host application and provide user data in response to the request data. The OTT connection 1450 may transfer both the request data and the user data. The UE's client application may interact with the user to generate the user data that it provides to the host application through the OTT connection 1450.

The OTT connection 1450 may extend via a connection 1460 between the host 1402 and the network node 1404 and via a wireless connection 1470 between the network node 1404 and the UE 1406 to provide the connection between the host 1402 and the UE 1406. The connection 1460 and wireless connection 1470, over which the OTT connection 1450 may be provided, have been drawn abstractly to illustrate the communication between the host 1402 and the UE 1406 via the network node 1404, without explicit reference to any intermediary devices and the precise routing of messages via these devices.

As an example of transmitting data via the OTT connection 1450, in step 1408, the host 1402 provides user data, which may be performed by executing a host application. In some embodiments, the user data is associated with a particular human user interacting with the UE 1406. In other embodiments, the user data is associated with a UE 1406 that shares data with the host 1402 without explicit human interaction. In step 1410, the host 1402 initiates a transmission carrying the user data towards the UE 1406. The host 1402 may initiate the transmission responsive to a request transmitted by the UE 1406. The request may be caused by human interaction with the UE 1406 or by operation of the client application executing on the UE 1406. The transmission may pass via the network node 1404, in accordance with the teachings of the embodiments described throughout this disclosure. Accordingly, in step 1412, the network node 1404 transmits to the UE 1406 the user data that was carried in the transmission that the host 1402 initiated, in accordance with the teachings of the embodiments described throughout this disclosure. In step 1414, the UE 1406 receives the user data carried in the transmission, which may be performed by a client application executed on the UE 1406 associated with the host application executed by the host 1402.

In some examples, the UE 1406 executes a client application which provides user data to the host 1402. The user data may be provided in reaction or response to the data received from the host 1402. Accordingly, in step 1416, the UE 1406 may provide user data, which may be performed by executing the client application. In providing the user data, the client application may further consider user input received from the user via an input/output interface of the UE 1406. Regardless of the specific manner in which the user data was provided, the UE 1406 initiates, in step 1418, transmission of the user data towards the host 1402 via the network node 1404. In step 1420, in accordance with the teachings of the embodiments described throughout this disclosure, the network node 1404 receives user data from the UE 1406 and initiates transmission of the received user data towards the host 1402. In step 1422, the host 1402 receives the user data carried in the transmission initiated by the UE 1406.

One or more of the various embodiments improve the performance of OTT services provided to the UE 1406 using the OTT connection 1450, in which the wireless connection 1470 forms the last segment. More precisely, disclosed embodiments can enable a communication network (e.g., 5G network) to properly classify encrypted UE application traffic, including encrypted DNS traffic. Furthermore, embodiments facilitate these operations without requiring an ASP to install and/or maintain associated PFDs in the NEF or similar network repository. Additionally, embodiments enable ASPs to define less complex PFDs based on domain name rather than IP address, even when encrypted DNS is used. In this manner, embodiments improve network functionality for handling of traffic for OTT services, which increases the value of such services to both end users and service providers (e.g., ASPs).

In an example scenario, factory status information may be collected and analyzed by the host 1402. As another example, the host 1402 may process audio and video data which may have been retrieved from a UE for use in creating maps. As another example, the host 1402 may collect and analyze real-time data to assist in controlling vehicle congestion (e.g., controlling traffic lights). As another example, the host 1402 may store surveillance video uploaded by a UE. As another example, the host 1402 may store or control access to media content such as video, audio, VR or AR which it can broadcast, multicast or unicast to UEs. As other examples, the host 1402 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1450 between the host 1402 and UE 1406, in response to variations in the measurement results. The measurement procedure and/or the network functionality for reconfiguring the OTT connection may be implemented in software and hardware of the host 1402 and/or UE 1406. In some embodiments, sensors (not shown) may be deployed in or in association with other devices through which the OTT connection 1450 passes; the sensors may participate in the measurement procedure by supplying values of the monitored quantities exemplified above, or supplying values of other physical quantities from which software may compute or estimate the monitored quantities. The reconfiguring of the OTT connection 1450 may include message format, retransmission settings, preferred routing etc.; the reconfiguring need not directly alter the operation of the network node 1404. Such procedures and functionalities may be known and practiced in the art. In certain embodiments, measurements may involve proprietary UE signaling that facilitates measurements of throughput, propagation times, latency and the like, by the host 1402. The measurements may be implemented in that software causes messages to be transmitted, in particular empty or ‘dummy’ messages, using the OTT connection 1450 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Embodiments of the techniques and apparatus described herein also include, but are not limited to, the following enumerated examples:

A1. A method for a network data analytics function (NWDAF) configured to assist with application detection in a communication network, the method comprising:
receiving, from a consumer network function (cNF) of the communication network, an analytic request related to assisted application detection;
based on the analytic request, sending to a first DNS resolver associated with the communication network an exposure request for events related to fully qualified domain name (FQDN)-to-address mapping for application servers associated with applications;
receiving from the first DNS resolver a first FQDN associated with a first application, in accordance with the exposure request;
based on the first FQDN, determining one or more packet flow descriptions (PFDs) associated with the first application; and
sending to the cNF an analytic result comprising the one or more PFDs, in accordance with the analytic request.
   A2. The method of embodiment A1, wherein the analytic request includes one or more of the following parameters that define a filter for the requested analytic: area of interest (AOI), single network slice selection assistance information (S-NSSAI), and data network name (DNN).
   A3. The method of embodiment A2, further comprising sending to a network repository function (NRF) of the communication network a discovery request for DNS resolvers associated with the communication network, wherein the discovery request includes the one or more parameters that define the filter for the requested analytic.
   A4. The method of embodiment A3, further comprising, in response to the discovery request, receiving from the NRF an identifier of the first DNS resolver and a profile for the first DNS resolver, wherein sending the exposure request to the first DNS resolver is based on at least one of the identifier and the profile.
   A5. The method of any of embodiments A1-A4, wherein determining the one or more PFDs based on the first FQDN comprises:
determining an application identifier that corresponds to the first FQDN; and
selecting the one or more PFDs based on their association with the application identifier.
   A6. The method of embodiment A5, wherein determining an application identifier that corresponds to the first FQDN comprises:
sending the first FDQN to a network exposure function (NEF) of the communication network; and
receiving from the NEF a response including the application identifier.
   A7. The method of any of embodiments A1-A5, wherein the cNF is a network exposure function (NEF) of the communication network, or a unit or sub-function thereof.
   B1. A method for a domain name service (DNS) resolver configured to assist with application detection in a communication network, the method comprising:
receiving, from a network data analytics function (NWDAF) of the communication network, an exposure request for events related to fully qualified domain name (FQDN)-to-address mapping for application servers associated with applications;
subsequently mapping a first FQDN to an address for an application server associated with a first application; and
sending the first FQDN to the NWDAF in accordance with the exposure request.
   B2. The method of embodiment B1, further comprising sending to a network repository function (NRF) of the communication network a request to register capabilities of the DNS resolver, wherein the exposure request is received based on the registering of capabilities.
   B3. The method of embodiment B2, wherein the request to register capabilities of the DNS resolver is an Nnrf_Registration Request message that includes the following information:
an identifier of the DNS resolver (DNS-ID);
an indication of support for exposure of events related to FQDN-to-address mapping; and DNS resolver configuration information including one or more of the following: area of interest (AOI), single network slice selection assistance information (S-NSSAI), and data network name (DNN).
   C1. A method for a consumer network function (cNF) of a communication network, the method comprising:
sending, to a network data analytics function (NWDAF) of the communication network, an analytic request related to assisted application detection; and
receiving from the NWDAF an analytic result comprising one or more packet flow descriptions (PFDs) associated with a first application, in accordance with the analytic request.
   C2. The method of embodiment C1, further comprising sending the one or more PFDs associated with the first application to a unified data repository (UDR) of the communication network for storage.
   C3. The method of any of embodiments C1-C2, further comprising sending the one or more PFDs associated with the first application to a user plane function (UPF) of the communication network.
   C4. The method of any of embodiments C1-C3, wherein the analytic request includes one or more of the following parameters that define a filter for the requested analytic: area of interest (AOI), single network slice selection assistance information (S-NSSAI), and data network name (DNN).
   C5. The method of any of embodiments C1-C4, wherein the cNF is a network exposure function (NEF), or a unit or sub-function thereof.
   D1. A method for a network repository function (NRF) of a communication network, the method comprising:
receiving, from a first domain name service (DNS) resolver associated with the communication network, a request to register capabilities of the first DNS resolver;
storing the first DNS resolver's capabilities in a profile for the first DNS resolver, in accordance with the request;
receiving, from a network data analytics function (NWDAF) of the communication network, a discovery request for DNS resolvers associated with the communication network, wherein the discovery request includes one or more parameters that define an analytic filter;
determining that the stored capabilities of the first DNS resolver match the one or more parameters included in the discovery request; and
sending to the NWDAF a discovery response that includes an identifier of the first DNS resolver and the profile for the first DNS resolver.
   D2. The method of embodiment B2, wherein the request to register capabilities of the DNS resolver is an Nnrf_Registration Request message that includes the following information:
the identifier of the first DNS resolver (DNS-ID); an indication of support for exposure of events related to FQDN-to-address mapping; and
DNS resolver configuration information including one or more of the following: area of interest (AOI), single network slice selection assistance information (S-NSSAI), and data network name (DNN).
   E1. A method for a unified data repository (UDR) of a communication network, the method comprising:
receiving, from a consumer network function (cNF) of the communication network, one or more packet flow descriptions (PFDs) associated with a first application; and
storing the one or more PFDs as application data for the first application.
   E2. The method of embodiment E1, further comprising:
receiving, from a second cNF of the communication network, a request for application data associated with the first application; and
in response to the request, retrieving the stored one or more PFDs and sending the retrieved one or more PFDs to the second cNF.
   E3. The method of any of embodiments E1-E2, wherein the cNF is a network exposure function (NEF), or a unit or sub-function thereof.
   F1. A network data analytics function (NWDAF) configured to assist with application detection in a communication network, wherein:
the NWDAF is implemented by communication interface circuitry and processing circuitry that are operably coupled; and
the processing circuitry and interface circuitry are configured to perform operations corresponding to any of the methods of embodiments A1-A7.
   F2. A network data analytics function (NWDAF) configured to assist with application detection in a communication network, the NWDAF being further configured to perform operations corresponding to any of the methods of embodiments A1-A7.
   F3. A non-transitory, computer-readable medium storing computer-executable instructions that, when executed by processing circuitry associated with a network data analytics function (NWDAF) configured to assist with application detection in a communication network, configure the NWDAF to perform operations corresponding to any of the methods of embodiments A1-A7.
   F4. A computer program product comprising computer-executable instructions that, when executed by processing circuitry associated with a network data analytics function (NWDAF) configured to assist with application detection in a communication network, configure the NWDAF to perform operations corresponding to any of the methods of embodiments A1-A7.
   G1. A domain name service (DNS) resolver configured to assist with application detection in a communication network, wherein:
the DNS resolver is implemented by communication interface circuitry and processing circuitry that are operably coupled; and
the processing circuitry and interface circuitry are configured to perform operations corresponding to any of the methods of embodiments B1-B3.
   G2. A domain name service (DNS) resolver configured to assist with application detection in a communication network, the DNS resolver being further configured to perform operations corresponding to any of the methods of embodiments B1-B3.
   G3. A non-transitory, computer-readable medium storing computer-executable instructions that, when executed by processing circuitry associated with a domain name service (DNS) resolver configured to assist with application detection in a communication network, configure the DNS resolver to perform operations corresponding to any of the methods of embodiments B1-B3.
   G4. A computer program product comprising computer-executable instructions that, when executed by processing circuitry associated with a domain name service (DNS) resolver configured to assist with application detection in a communication network, configure the DNS resolver to perform operations corresponding to any of the methods of embodiments B1-B3.
   H1. A network exposure function (NEF) configured to operate in a communication network, wherein:
the NEF is implemented by communication interface circuitry and processing circuitry that are operably coupled; and
the processing circuitry and interface circuitry are configured to perform operations corresponding to any of the methods of embodiments C1-C5.
   H2. A network exposure function (NEF) configured to operate in a communication network, the NEF being further configured to perform operations corresponding to any of the methods of embodiments C1-C5.
   H3. A non-transitory, computer-readable medium storing computer-executable instructions that, when executed by processing circuitry associated with a network exposure function (NEF) configured to operate in a communication network, configure the NEF to perform operations corresponding to any of the methods of embodiments C1-C5.
   H4. A computer program product comprising computer-executable instructions that, when executed by processing circuitry associated with a network exposure function (NEF) configured to operate in a communication network, configure the NEF to perform operations corresponding to any of the methods of embodiments C1-C5.
   I1. A network repository function (NRF) configured to operate in a communication network, wherein:
the NRF is implemented by communication interface circuitry and processing circuitry that are operably coupled; and
the processing circuitry and interface circuitry are configured to perform operations corresponding to any of the methods of embodiments D1-D2.
   I2. A network repository function (NRF) configured to operate in a communication network, the NRF being further configured to perform operations corresponding to any of the methods of embodiments D1-D2.
   I3. A non-transitory, computer-readable medium storing computer-executable instructions that, when executed by processing circuitry associated with a network repository function (NRF) configured to operate in a communication network, configure the NRF to perform operations corresponding to any of the methods of embodiments D1-D2.
   I4. A computer program product comprising computer-executable instructions that, when executed by processing circuitry associated with a network repository function (NRF) configured to operate in a communication network, configure the NRF to perform operations corresponding to any of the methods of embodiments D1-D2.
   J1. A unified data repository (UDR) configured to operate in a communication network, wherein:
the UDR is implemented by communication interface circuitry and processing circuitry that are operably coupled; and
the processing circuitry and interface circuitry are configured to perform operations corresponding to any of the methods of embodiments E1-E3.
   J2. A unified data repository (UDR) configured to operate in a communication network, the UDR being further configured to perform operations corresponding to any of the methods of embodiments E1-E3.
   J3. A non-transitory, computer-readable medium storing computer-executable instructions that, when executed by processing circuitry associated with a unified data repository (UDR) configured to operate in a communication network, configure the UDR to perform operations corresponding to any of the methods of embodiments E1-E3.
   J4. A computer program product comprising computer-executable instructions that, when executed by processing circuitry associated with a unified data repository (UDR) configured to operate in a communication network, configure the UDR to perform operations corresponding to any of the methods of embodiments E1-E3.

1.-32. (canceled)

33. A method for a network data analytics function (NWDAF) configured to assist with application detection in a communication network, the method comprising:
receiving, from a consumer network function (cNF) of the communication network, an analytic request related to assisted application detection;
based on the analytic request, sending to a first domain name service (DNS) resolver associated with the communication network an exposure request for events related to fully qualified domain name (FQDN)-to-address mapping for application servers associated with applications;
receiving from the first DNS resolver a first FQDN associated with a first application, in accordance with the exposure request;
based on the first FQDN, determining one or more packet flow descriptions (PFDs) associated with the first application; and
sending to the cNF an analytic result comprising the one or more PFDs, in accordance with the analytic request.

34. The method of claim 33, wherein the analytic request includes one or more of the following parameters that define a filter for the requested analytic: area of interest (AOI); single network slice selection assistance information (S-NSSAI); and data network name (DNN).

35. The method of claim 34, further comprising sending to a network repository function (NRF) of the communication network a discovery request for DNS resolvers associated with the communication network, wherein the discovery request includes the one or more parameters that define the filter for the requested analytic.

36. The method of claim 35, further comprising, in response to the discovery request, receiving from the NRF an identifier of the first DNS resolver and a profile for the first DNS resolver, wherein sending the exposure request to the first DNS resolver is based on at least one of the identifier and the profile.

37. The method of claim 33, wherein determining the one or more PFDs based on the first FQDN comprises:
determining an application identifier that corresponds to the first FQDN; and
selecting the one or more PFDs based on their association with the application identifier.

38. The method of claim 37, wherein determining an application identifier that corresponds to the first FQDN comprises:
sending the first FDQN to a network exposure function (NEF) of the communication network; and
receiving from the NEF a response that includes the application identifier.

39. The method of claim 33, wherein the cNF is a network exposure function (NEF) or a unit or sub-function thereof.

40. A method for a domain name service, DNS, resolver configured to assist with application detection in a communication network, the method comprising:
receiving, from a network data analytics function (NWDAF) of the communication network, an exposure request for events related to fully qualified domain name (FQDN)-to-address mapping for application servers associated with applications;
subsequently mapping a first FQDN to an address for an application server associated with a first application; and
sending the first FQDN to the NWDAF in accordance with the exposure request.

41. The method of claim 40, further comprising sending to a network repository function (NRF) of the communication network a request to register capabilities of the DNS resolver, wherein the exposure request is received based on the registering of capabilities.

42. The method of claim 41, wherein the request to register capabilities of the DNS resolver is an Nnrf_Registration Request message that includes the following information:
an identifier of the DNS resolver (DNS-ID);
an indication of support for exposure of events related to FQDN-to-address mapping; and
configuration information for the DNS resolver, including one or more of the following:
area of interest (AOI); single network slice selection assistance information (S-NSSAI);
and data network name (DNN).

43. Network equipment arranged to implement a network data analytics function (NWDAF) configured to assist with application detection in a communication network, the network equipment comprising:
communication interface circuitry configured to communicate with network functions (NFs) of the communication network and with a first domain name service (DNS) resolver; and
processing circuitry operably coupled to the communication interface circuitry, wherein the processing circuitry and the communication interface circuitry are configured to:
receive, from a consumer network function (cNF) of the communication network, an analytic request related to assisted application detection;
based on the analytic request, send to the first DNS resolver associated with the communication network an exposure request for events related to fully qualified domain name (FQDN)-to-address mapping for application servers associated with applications;
receive from the first DNS resolver a first FQDN associated with a first application, in accordance with the exposure request;
based on the first FQDN, determine one or more packet flow descriptions (PFDs) associated with the first application; and
send to the cNF an analytic result comprising the one or more PFDs, in accordance with the analytic request.

44. The network equipment of claim 43, wherein the analytic request includes one or more of the following parameters that define a filter for the requested analytic: area of interest (AOI); single network slice selection assistance information (S-NSSAI); and data network name (DNN).

45. The network equipment of claim 44, wherein the processing circuitry and the communication interface circuitry are further configured to send to a network repository function (NRF) of the communication network a discovery request for DNS resolvers associated with the communication network, wherein the discovery request includes the one or more parameters that define the filter for the requested analytic.

46. The network equipment of claim 45, wherein the processing circuitry and the communication interface circuitry are further configured to, in response to the discovery request, receive from the NRF an identifier of the first DNS resolver and a profile for the first DNS resolver, wherein the exposure request is sent to the first DNS resolver based on at least one of the identifier and the profile.

47. The network equipment of claim 43, wherein the processing circuitry and the communication interface circuitry are configured to determine the one or more PFDs based on the following operations:
determining an application identifier that corresponds to the first FQDN; and
selecting the one or more PFDs based on their association with the application identifier.

48. The network equipment of claim 47, wherein the processing circuitry and the communication interface circuitry are configured to determine an application identifier that corresponds to the first FQDN based on the following operations:
sending the first FDQN to a network exposure function (NEF) of the communication network; and
receiving from the NEF a response that includes the application identifier.

49. Network equipment arranged to implement a domain name service (DNS) resolver configured to assist with application detection in a communication network, the network equipment comprising:
communication interface circuitry configured to communicate with network functions (NFs) of the communication network; and
processing circuitry operably coupled to the communication interface circuitry, wherein the processing circuitry and the communication interface circuitry are configured to perform the method of claim 40.

50. A communication network comprising:
the network equipment arranged to implement the network data analytics function, (NWDAF) in accordance with claim 43; and
network equipment arranged to implement a network repository function (NRF) configured to:
receive, from the first DNS resolver, a request to register capabilities of the first DNS resolver;
store the first DNS resolver's capabilities in a profile for the first DNS resolver, in accordance with the request;
receive, from the NWDAF, a discovery request for DNS resolvers associated with the communication network, wherein the discovery request includes one or more parameters that define an analytic filter;
determine that the stored capabilities of the first DNS resolver match the one or more parameters included in the discovery request; and
send to the NWDAF a discovery response that includes an identifier of the first DNS resolver and the profile for the first DNS resolver.

51. The communication network of claim 50, wherein one or more of the following applies:
the request to register capabilities of the first DNS resolver is an Nnrf_Registration Request message that includes the following information:
an identifier of the first DNS resolver (DNS-ID);
an indication of first DNS resolver support for exposure of events related to fully qualified domain name (FQDN)-to-address mapping; and
configuration information for the first DNS resolver, including one or more of the following: area of interest (AOI); single network slice selection assistance information (S-NSSAI); and data network name (DNN); and
the one or more parameters that define the analytic filter include one or more of the following: the AOI; the S-NSSAI; and the DNN.

52. The communication network of claim 51, further comprising network equipment arranged to implement a consumer network function (cNF) configured to:
send, to the NWDAF, an analytic request related to assisted application detection; and
receive, from the NWDAF in accordance with the analytic request, an analytic result comprising one or more packet flow descriptions (PFDs) associated with a first application, wherein one or more of the following applies:
the cNF is a network exposure function (NEF) or a unit or sub-function thereof ;
the discovery request received by the NRF is based on the analytic request sent by the cNF; and
the analytic request includes the one or more parameters that define the analytic filter.
